(19) United States
(12) Patent Application Publication
(10) Pub. No.: US 2019/0019482 A1
(43) Pub. Date: Jan. 17, 2019

(54) REMOTELY OPERABLE SOUND EFFECT CONTROL DEVICE AND SYSTEM

(71) Applicants: Doug Classe, Orlando, FL (US); Scott Jordan, Orlando, FL (US)

(72) Inventors: Doug Classe, Orlando, FL (US); Scott Jordan, Orlando, FL (US)

(21) Appl. No.: 15/836,177

(22) Filed: Dec. 8, 2017

Related U.S. Application Data
(60) Provisional application No. 62/532,550, filed on Jul. 14, 2017.

(51) Int. Cl. G10H 1/00; G10H 1/18; G06F 3/16; G10H 1/34

(52) U.S. Cl. CPC G10H 1/0008; G10H 1/18; G10H 1/0091; G06F 3/162; G06F 3/165; G10H 1/348; G10H 1/0066

(57) ABSTRACT

A remotely operable sound effect control device and system includes a control device having a wireless communication unit for communicating with a smartphone or other electronic device running a mobile application. The control device includes a plurality of device connectors for engaging a plurality of sound effect and bypass loop devices. The control device includes a memory and display unit for storing and retrieving pre-programmed sound settings for instructing each of the connected devices to selectively activate sound effects. The mobile application includes functionality for generating a virtual representation of each connected effect and bypass loop device, and for changing an operating status of the same via the virtual representation.

### CROSS-REFERENCE TO RELATED APPLICATIONS

This application claims the benefit of U.S. Application Ser. No. 62/532,550 filed on Jul. 14, 2017, the contents of which are incorporated herein by reference.

### TECHNICAL FIELD

The present invention relates generally to systems and devices for controlling special effects and distortions on audio signals, and more particularly to a control device for remotely operating a plurality of audio loops.

### BACKGROUND

The statements in this section merely provide background information related to the present disclosure and may not constitute prior art.

Musicians playing amplified guitars often utilize one or more small, electronic sound altering devices to change the natural sound of their instrument. These sound effect devices are commonly called effect pedals, and are typically designed to rest on the floor during use. This feature allows a musician to selectively activate each pedal using their foot, thereby leaving the user's hands free to play the instrument.

Guitar effect pedals were introduced in the late 1960's, and the prior art generally discusses that the effects able to be produced at this time are virtually unlimited. Of these devices, many comprise analog devices which have an on/off feature, whereas other devices include digital effect pedals with enhanced features and functionality. As such, skilled musicians will often utilize a plurality of different analog and digital effect pedals when playing on stage or in a recording studio, for example.

In addition to the above, there are several known bypass loop systems (e.g., looper) which can be connected to multiple analog effect pedals in order to allow a musician to selectively control the operating status of the same. Additionally, there are many known effect control devices which allow a user to program the operation of a bypass loop device to activate a first group of effect pedals for one song, and to then activate a second group of effect pedals for a second song. Such a feature prevents the user from having to activate and deactivate each individual effect pedal between songs.

Owing to the analog switching components of traditional loop and controller systems, it is common for a single controller to be used with each bypass loop device, and necessary for the user to have physical access to each controller in order to program the same. To this end, musicians will typically pre-program the controllers to include a plurality of sound effect groups for each song they are about to play. Although this is fine when the musician only plays the anticipated songs in a particular order, a problem arises when the musician wants to spontaneously change the grouping. In such a situation, he or she must stop playing and physically program the controller to instruct the bypass loop device to include a new effect group, or have a sound engineer physically access the system to do the same.

Accordingly, it would be beneficial to provide a remotely operable sound effect controller that can communicate directly with any number of bypass loop devices, and digital effect devices, so as to overcome the drawbacks described above.

### SUMMARY OF THE INVENTION

The present invention is directed to a remotely operable sound effect control device and system. In one embodiment, the system can include a control device having a wireless communication unit that can communicate with a smartphone or other electronic device running a mobile application. The control device can include a plurality of device connectors for engaging a plurality of external effect devices and bypass loop devices.

The control device can further include a memory and display unit for storing and retrieving pre-programmed sound settings for instructing each of the connected effect and bypass loop devices to selectively activate a sound effect.

The mobile application can include functionality for generating a virtual representation of each connected effect device and bypass loop device, and can receive instructions from a user to selectively engage and disengage particular sound effects. Upon receiving a change request on the application, the smartphone can send wireless instructions to the control unit to implement the requested change immediately on the connected device.

In another embodiment, the smartphone App can access the internet and/or the smartphone memory and retrieve an unlimited number of pre-programmed sound configurations for transmission to the effect device and bypass loop device via the control unit.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is an exemplary remotely operable sound effect control system that is useful for understanding the inventive concepts disclosed herein.

FIG. 2 is a perspective view of the control device, in accordance with one embodiment of the invention.

FIG. 3 is a simplistic block diagram of the control device, in accordance with one embodiment of the invention.

FIG. 4 is a schematic diagram of the control system in operation, in accordance with one embodiment of the invention.

FIG. 5 illustrates an exemplary display screen which can be generated by the control App, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

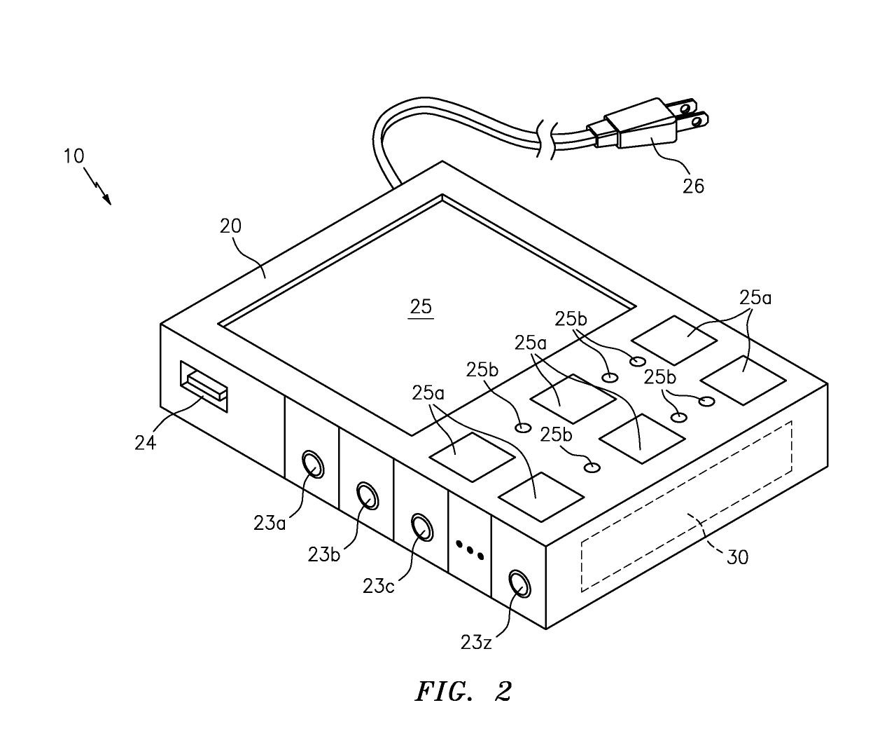

Identical reference numerals are used for like elements of the invention or elements of like function. For the sake of clarity\, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 2.

In the below described examples, the remotely operable sound effect control device can be communicatively linked to a smartphone mobile application (i.e., App) which can be downloaded and installed as an application after purchase of the smartphone device. Of course, the inventive concepts disclosed herein are not to be construed as limiting to a smartphone or a mobile App.

To this end, any type of instruction sets, in any form of programming language that can be executed on a processor enabled device are also contemplated. Moreover, any type of processor enabled device that is capable of providing two way communication with the sound effect control device can be utilized herein. Several nonlimiting additional examples include Bluetooth enabled phones and tablet computers, portable computers, PDAs, portable music devices (MP3 players), and/or wearable devices such as smartphone watches, for example.

In either instance, a user's smartphone or tablet device generally includes installed software adapted to generate icons for launching the sound effect controller App 50, and to display same on the display screen of the smartphone device. The icon can be activated through use of a touch sensitive smartphone or tablet screen, and/or a keypad, for example. Selecting the icon launches the system application and/or launches a linked web page through internet connectivity wherein the below described presentation screens are generated. Selecting the icon also activates the portable electronic devices' wireless communication unit such as a Bluetooth transceiver, for example.

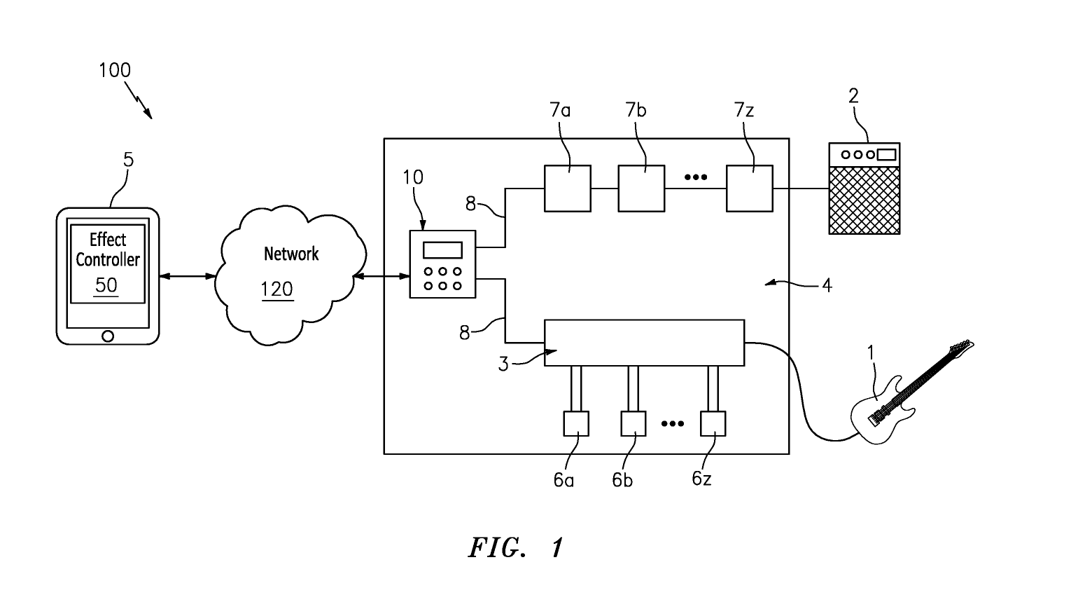

FIG. 1 illustrates one embodiment of a remotely operable sound effect control system 100 that is useful for understanding the inventive concepts disclosed herein. The system 100 can include a remotely operated sound effect controller 10 that is connected to any number of commercially available bypass loop device(s) 3 and/or sound effect devices 7a-7z, such as digital effect pedals, for example. As shown, the bypass loop device is connected to any number of commercially available sound effect devices 6a-6z, such as an analog effect pedal, for example. In the preferred embodiment, the system components can be positioned on a pedalboard 4 which can facilitate communication with an instrument 1 and/or speaker 2; however the pedalboard is not required.

The system 100 can also include a controller App 50 that is loaded onto a smartphone 5 or other such device. As such, the App 50 can utilize the processing power, storage and communicative abilities of the smartphone to store an unlimited number of sound configurations, and can transmit the same to the controller 10 for dissemination to the effect and bypass devices in order to allow a user to selectively alter the sound generated by the musical instrument before it is amplified and/or sent to the speaker. To this end, the App can allow a user to make instantaneous changes to a connected device at any time without having to physically access the effect devices or the controller itself.

Although illustrated for use with an electric guitar 1, this is for illustrative purposes only, as the inventive concepts disclosed herein can be utilized with any type of instrument, regardless of the manufacturer and/or intended use of the same.

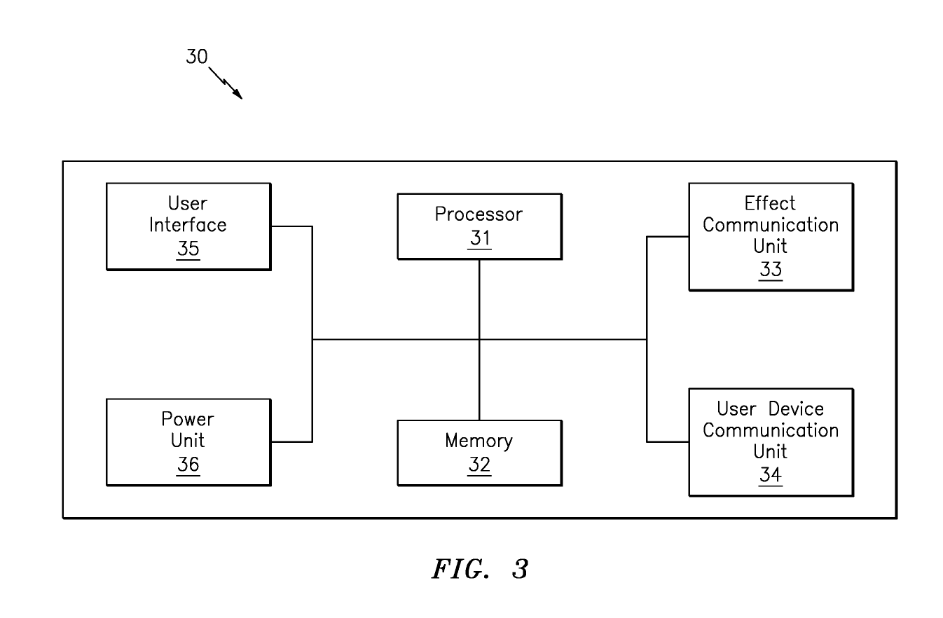

FIGS. 2 and 3 illustrate one embodiment of the system control device 10 for use with the system 100. The device 10 can include a main body 20 having a plurality of loop device connectors 23a-23z, a visual display screen 25, and an internal controller 30.

The main body 20 can include any number of different shapes and sizes that are suitable for housing the device components. In the preferred embodiment, the main body will be constructed from a sturdy material such as steel or aluminum, for example; however other construction materials such as plastics and the like are also contemplated.

The internal controller 30 can function to control the operation of any number of connected bypass loop devices and sound effect devices, and can further function to communicate with the smartphone device 5 having the control App 50 installed thereon. As shown, the controller can include one or more processors 31 that are conventionally connected to a memory 32, an effect communication unit 33, a user device communication unit 34, a user interface 35, and a power unit 36.

Although illustrated as separate elements, those of skill in the art will recognize that one or more system components may be, or may include, one or more printed circuit boards (PCB), containing an integrated circuit or circuits for completing the activities described herein, and the CPU may be one or more integrated circuits having firmware for causing the circuitry to complete the activities described herein. Additionally, one or more of the controller elements may also be arranged as a completely separate element (such as the power source, for example) that are communicatively linked to the processor.

The processor/CPU 31 can act to execute program code stored in the memory 32 in order to allow the device to perform the functionality described herein. Although illustrated as a single processor, this is for ease of illustration, as any number of individual sub processors can also be provided. In either instance, processors are extremely well known in the art, therefore no further description will be provided.

Memory 32 can act to store operating instructions in the form of program code for the processor(s) 31 to execute. Although illustrated as a single component, memory 32 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device. Additionally, memory 32 can also include one or more cache memories that provide temporary storage of at least some program code in order to reduce the number of times program code must be retrieved from the bulk storage device during execution. Each of these devices are well known in the art.

The effect communication unit 33 can function to send and receive information with a plurality of connected effect and/or bypass loop devices. In the preferred embodiment, the unit can include, comprise, or consist of a MIDI (Musical Instrument Digital Interface standard) communication module that is communicatively linked with a plurality of MIDI jacks 23a-23z located along the main body 20. As shown, the jacks can receive any number of communication cables, such as MIDI cables 8, for example, which can communicate directly with the effect and bypass loop device(s). The use and operation of MIDI controllers are also described in U.S. Patent Publication No. 2005/0056142, the contents of which are incorporated herein by reference. Of course, any number of other communication devices and protocols are also contemplated. Several nonlimiting examples include DIN, ¼″ MIDI format, Tap Tempo, TRS Switching and other digital type control signals, for example.

The user device communication unit 34 can include any number of devices capable of communicating with a smartphone or other external processor enabled device. In one embodiment, the unit 34 can include a physical communication jack such as a USB port 24, for example. Additionally, the communication unit 34 can include, comprise or consist of a wireless communication module such as a Bluetooth transceiver, for example, that is capable of providing direct wireless communication with a smartphone running the controller App 50. Of course, any number of other known transmission and reception mechanisms and/or communication protocols can also be utilized herein, several nonlimiting examples include unique radio frequency transmitter and receivers, Z-wave, and/or infrared (IR), for example. Alternatively or in addition to the above, the communication unit can include or comprise any type of network adapter capable of communicating over a network 120 such as WI-FI, LAN, WAN, a cellular communications network, and/or the internet, for example.

The user interface 35 can function to accept user inputs and/or to provide operating information to a device user. In one embodiment, the user interface 35 can include or control a visual display screen 25. As described herein, a visual display can include any type of known device capable of presenting information to a user via a screen. Several nonlimiting examples include LCD displays, plasma, LED displays, electro-luminescent displays and the like. Additionally, the visual display screen 25 can also include or comprise a Graphic User Interface (GUI) capable of performing two way communication with a device user.

In various embodiments, the user interface 35 can also include or control one or more buttons/switches 25a, that are connected to the processor 31 so as to activate various programmatic functions. In addition to above, the input/output unit can further include or control any number of lights 25b so as to clearly indicate whether the device or device operation is in the ON or OFF operating state, for example.

The power unit 36 can include any number of components such as an A/C electrical power transformer and cord 26 capable of allowing the device to be powered from a standard electrical outlet. In the preferred embodiment, the power unit can be in communication with the pedalboard 4 and each system component will utilize the industry standard Boss 9v.

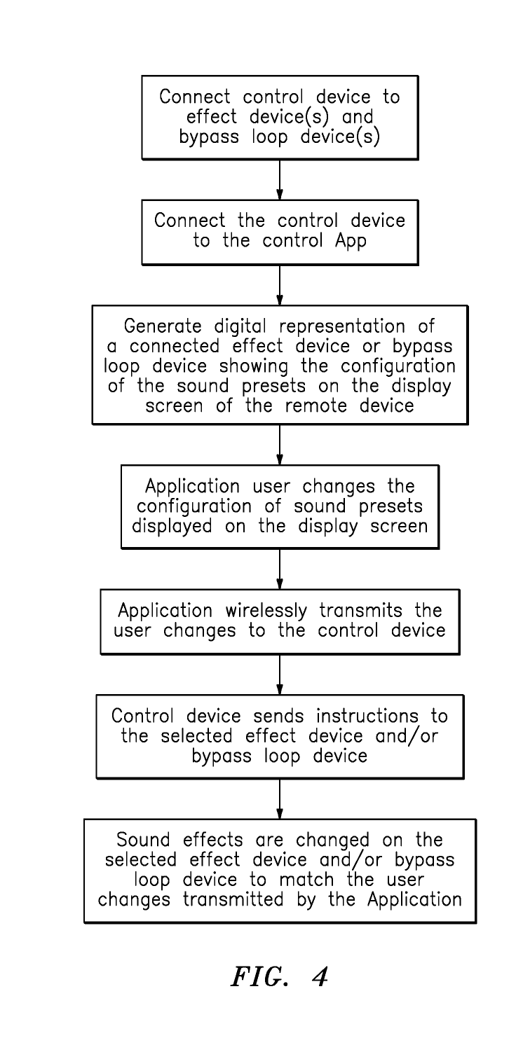

In operation, and as depicted schematically in FIG. 4, a user will first connect the control device 10 to one or more of the effect devices 7a-7z and the bypass loop device 3, via the connection jacks 23a-23z.

Once connected, the control device 10 will control the operation of each effect and bypass loop device, so as to selectively activate and control each sound effect 3a-3z and 7a-7z. In this regard, a user can operate the control device 10 via the display screen 25, buttons 25a or App 50. As such, the user can individually configure each bypass loop device/sound effect, or can select from any number of pre-stored configurations which can be retrieved from the control device memory 32 and/or in the smartphone device memory. As described herein, pre-store configurations or presets can include any number of distinct instruction sets for configuring each connected effect device to selectively activate and deactivate individual sound effects.

Next, a user can pair a smartphone 5 running the App 50 with the control device 10. At this time, the processor 31 can direct the communication unit 34 to send and receive information with the smartphone app 50 so as to allow the App to control the operation of each connected bypass loop device and connected sound effect device.

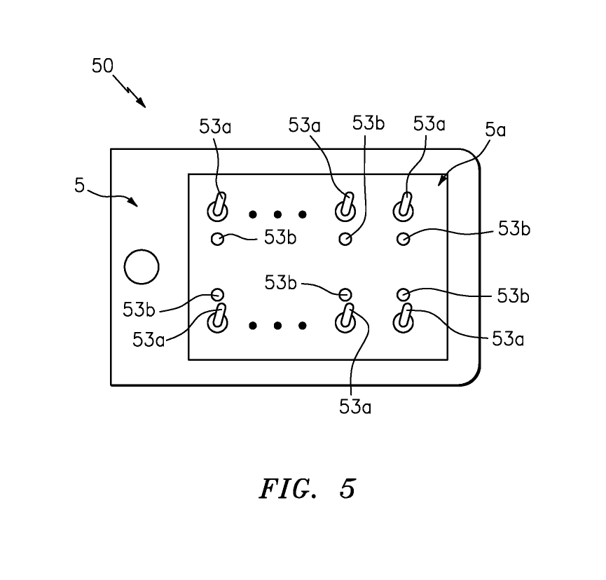

In one embodiment, the App 50 can generate a virtual representation of the controller 10, and each effect device 7a-7z and bypass loop device 3 on the smartphone screen 5a. As shown in FIG. 5, this virtual representation can include a plurality of virtual switches 53a and visual indicators 53b that correspond to the actual switches and lights found on the connected devices, including digital representations of additional lights showing which stored preset is active, and the like.

As such, the control device 10 and App 50 can exchange any and all information pertaining to the operating status and/or operating instructions for each connected effect and bypass loop device, including any and all sound loops, audio inputs, audio outputs, active sound effects, song tempos, and other functionality. To this end, the communication unit 34 can report the current operating status of each device such as which sound effects/bypass loops are active and/or which pre-stored configuration(s) are active at any given time to the App 50. The communication unit 34 can also instruct the App 50 to immediately update the digital representation of the effect device that is displayed on the smartphone, thereby providing a real time representation of the device settings to the App user at all times.

In addition to the above, the two way communication between the App 50 and the control device 10 allows the App 50 to remotely change the settings of each connected effect and bypass loop device. In one embodiment, changes can be made to a device when the App user engages one or more of the virtual switches 53a and/or selects from a list of pre-stored sound configurations stored on the smartphone memory and/or the internet, for example. When such selections are made on the App, the smartphone can wirelessly transmit the change request(s) to the communication unit 34 of the control device 10, which can transmit the change request directly to the connected effect and/or bypass loop device for implementation. Moreover, by utilizing the storage and/or internet capability of the smartphone running the App 50, a user can store and/or download an unlimited number of different sound configurations which can be immediately transmitted to the control device 10 for implementation by the connected effect devices.

Although described above as including a digital 1 for 1 representation of the effect device on the smartphone, the invention is not so limiting. As such, any number of different presentation screens can be provided for allowing the App user to communicate with the effect device in a wireless manner, in order to achieve the inventive concepts disclosed herein.

Accordingly, the above described system provides users with the ability to quickly and easily change the sound effects and other settings of any number of effects and bypass loop devices via a smartphone App, thereby eliminating the need to physically access the same during a performance.

As described herein, one or more elements of the control device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

As will be appreciated by one skilled in the art, aspects of the present invention may be embodied as a system, method or computer program product. Accordingly, aspects of the present invention may take the form of an entirely hardware embodiment, or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's smartphone, partly on the user's smartphone, as a stand-alone software package, partly on the user's smartphone and partly on a remote computer or entirely on the remote computer or server. In the latter scenario, the remote computer may be connected to the user's smartphone through any type of network, including a cellular network connection, a local area network (LAN) or a wide area network (WAN), or the connection may be made to an external computer (for example, through the Internet using an Internet Service Provider).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A sound effect control system for remotely controlling sound effect devices and bypass loop devices, said system comprising:
a control device that includes:
a main body,
a plurality of device connectors that are disposed along the main body, each of the device connectors being configured to connect to one of an effect device and a bypass loop device,
a display unit that is disposed along the main body, said display unit being configured to display an operating status of each of a connected effect device and a connected bypass loop device, and
a communication unit that is configured to perform wireless communication; and
a control device application that includes machine readable instructions for execution on an electronic device having a processor, a memory, a wireless communication unit, and a display screen, said application functioning to
generate a digital representation of each the connected effect device and bypass loop device, and
send and receive operating instructions with the communication unit of the control device.

2. The system of claim 1, wherein the digital representation of the connected effect device and bypass loop device further includes a plurality of virtual control switches and lighted elements that correspond to a plurality of control switches and lighted elements located on the connected effect device and bypass loop device.

3. The system of claim 2, wherein the control device application includes functionality for detecting that a virtual control switch has been engaged and sending a change request to the control device, and
wherein the control device includes a processor that instructs the connected effect device and bypass loop device to engage the corresponding control switch upon receiving the change request.

4. The system of claim 3, wherein engagement of the corresponding control switch transitions an associated sound effect between an on and off operating state.

5. The system of claim 4, wherein the communication unit functions to transmit an operating status of each sound effect of each connected device to the control device application, and
the control device application includes functionality for changing the digital representation of the connected device to conform to the received operating status.

6. The system of claim 1, wherein the plurality of device connectors includes at least one MIDI input jack and at least one MIDI output jack.

7. The system of claim 1, wherein the communication unit includes a Bluetooth transceiver.

8. The system of claim 1, wherein the communication unit includes a physical communication port for receiving instructions via a communication cable.

9. The system of claim 1, wherein the control device further includes an internal controller, comprising:
at least one memory;
a MIDI control module that is in communication with each of the device connectors;
a user interface unit that is in communication with the display unit;
a power unit; and
one or more processors that are in communication with, and control an operation of each of the power source, the user interface unit, the communication unit, the MIDI control module, and the memory.

10. The system of claim 9, wherein the memory is configured to store a plurality of preset operating states.

11. The system of claim 9, wherein the control device application further includes functionality for engaging the memory of the electronic device to retrieve one or more preset operating states for transmission to the control device.

12. The system of claim 9, wherein the control device application further includes functionality for engaging the memory of the electronic device to store one or more preset operating states that are received from the control device

13. The system of claim 9, wherein the control application further includes functionality for engaging the wireless communication unit of the electronic device to retrieve one or more preset operating states for transmission to the control device.
